(19) United States
(12) Patent Application Publication
(10) Pub. No.: US 2014/0313777 A1
(43) Pub. Date: Oct. 23, 2014

(54) LIGHT GUIDING PLATE AND BACKLIGHT MODULE USING SAME

(71) Applicant: HON HAI PRECISION INDUSTRY CO., LTD., New Taipei (TW)

(72) Inventor: LI-YING WANG HE, New Taipei (TW)

(73) Assignee: HON HAI PRECISION INDUSTRY CO., LTD., New Taipei (TW)

(21) Appl. No.: 14/221,268

(22) Filed: Mar. 20, 2014

(30) Foreign Application Priority Data
Apr. 23, 2013 (TW) 102114296

(51) Int. Cl. F21V 8/00

(52) U.S. Cl. CPC G02B 6/002
USPC 362/613; 362/621

(57) ABSTRACT

A light guiding plate includes a bottom surface, a light emitting surface opposite to the bottom surface, and a light incident surface perpendicularly connected between the bottom surface and the light emitting surface. The light guiding plate defines a plurality of recesses in the light incident surface. Each recess includes a concave surface, and the concave surface is connected between the light emitting surface and the bottom surface. Each concave surface forms a smooth curve on the light emitting surface. A distance between two points of the smooth curve the same distance away from the light incident surface gradually decreases along a direction away from the light incident surface.

### BACKGROUND

1. Technical Field

The present disclosure relates to light guiding elements, and particularly to a light guiding plate capable of improving brightness uniformity, and a backlight module using same.

2. Description of the related art

Backlight modules generally include a light guiding plate and a number of light sources located at a side of the light guiding plate. As a brightness of a central portion of the light source is greater than a brightness of a peripheral portion of the light source, luminous fluxes of light rays projected onto different points of an incident surface of the light guiding plate are different, which results in the light rays emitted from the light guiding plate forming alternating bright and dark strips.

Therefore, it is desirable to provide a light guiding plate and a backlight module to overcome the limitations described.

### BRIEF DESCRIPTION OF THE DRAWINGS

FIG. 1 is an isometric view of an embodiment of a backlight module.

FIG. 2 is a partial top view of a light guiding plate of the backlight module of FIG. 1.

FIG. 3 is a schematic view of a state of use of the backlight module of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

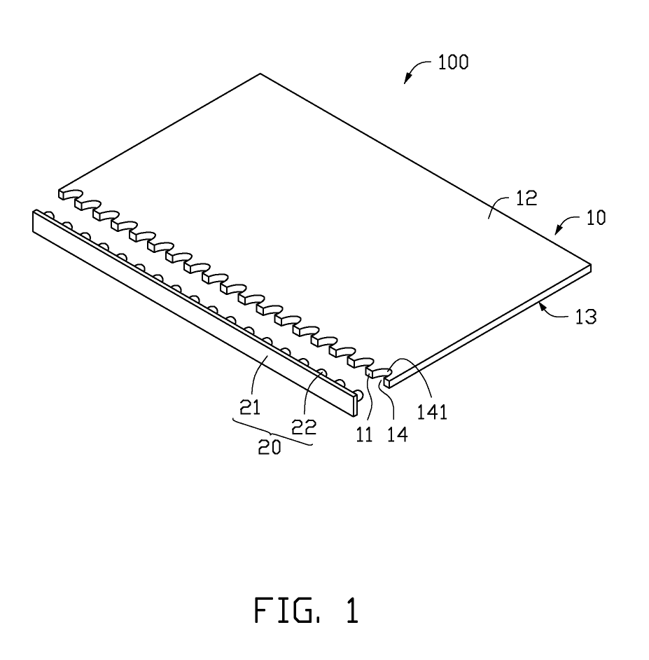

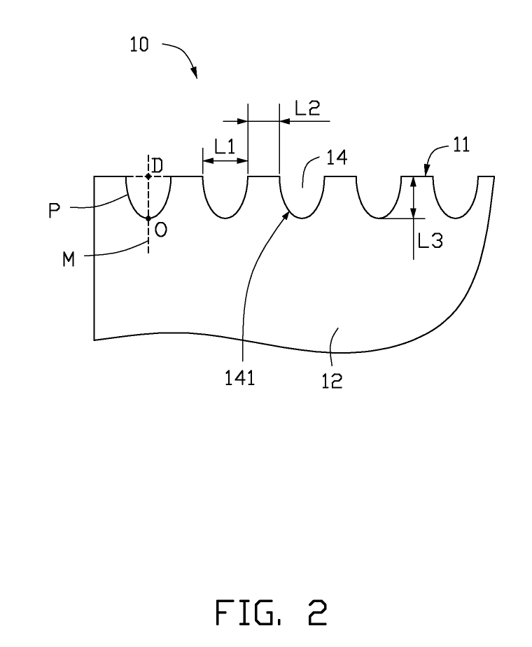

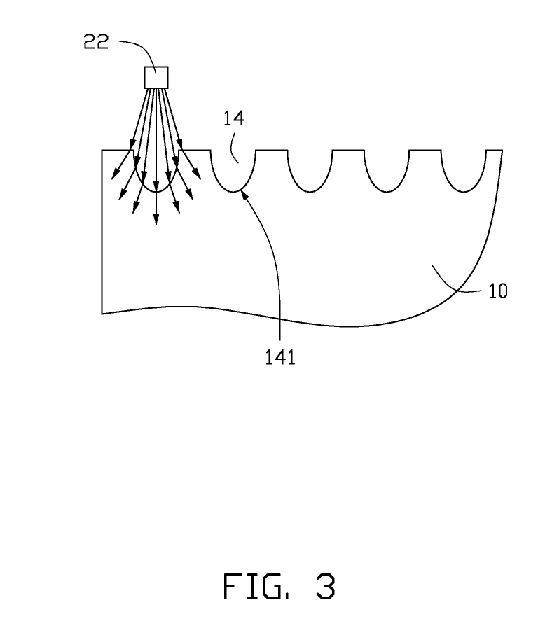

FIGS. 1-3 show an embodiment of a back light module 100, which is used in a light crystal display (not shown). The back light module 100 includes a light guiding plate 10 and a light source module 20. The light source module 20 emits light rays into the light guiding plate 10.

The light guiding plate 10 is substantially plate-shaped and made of polycarbonate, polymethyl methacrylate, methyl methacrylate, styrene copolymers, polyethylene terephthalate, polystyrene, or other suitable material. The light guiding plate 10 includes a light incident surface 11, a light emitting surface 12, and a bottom surface 13. The light emitting surface 12 is opposite to the bottom surface 13, and the light incident surface 11 is substantially perpendicularly connected between the light emitting surface 12 and the bottom surface 13.

The light guiding plate 10 defines a number of recesses 14 in the light incident surface 11. The recesses 14 are arranged at substantially equal intervals along a length of the light incident surface 11 and are defined through the light emitting surface 12 and the bottom surface 13. Shapes and sizes of the recesses 14 are substantially the same. Each recess 14 includes a concave surface 141, and the concave surface 141 is connected between the light emitting surface 12 and the bottom surface 13. Each concave surface 141 forms a smooth curve P on the light emitting surface 12. A distance between two points of the smooth curve P the same distance away from the light incident surface 11 gradually decreases along a direction away from the light incident surface 11.

In the embodiment, a width L1 of each recess 14 along an arrangement direction of the recesses 14 is from about 0.02 millimeter (mm) to about 0.04 mm. An interval L2 between two adjacent recesses 14 along an arrangement direction of the recesses 14 is from about 0.01 mm to about 0.03 mm. The interval L2 is a width of a section of the light incident surface 11 between two adjacent recesses 14 along an arrangement direction of the recesses 14. A maximum distance L3 between the concave surface 141 and the light incident surface 11 is from about 0.02 micrometer (um) to about 0.03 um.

In the embodiment, the smooth curve P is a parabola. A midpoint D is defined as a midpoint of the width L1. The smooth curve P is symmetrical about a perpendicular line M perpendicular to the light incident surface 11 and passing through the midpoint D. A lowest point O is an intersection point of the perpendicular line M and the smooth curve P. When the lowest point O serves as an origin of a coordinate plane, the perpendicular line M serves as a Y-axis, and a line perpendicular to the perpendicular line M and passing through the lowest point O serves as an X-axis. Thus, a mathematical equation of the smooth curve P is y=x²/0.009.

It should be understood that the light guiding plate 10 defines a microstructure, such as a prism structure, in the light incident surface 12. The microstructure improves a light emitting efficiency and a light emitting angle of the light rays. A reflective film is coated on the bottom surface 13 to improve a reflectance of the light rays projected onto the bottom surface 13.

The light source module 20 includes a supporting plate 21 and a number of light sources 22 located on a same side of the supporting plate 21. The light sources 22 are arranged at substantially equal intervals along a length of the supporting plate 21. The light sources 22 face the light incident surface 11 of the light guiding plate 10, and each light source 22 faces a central portion of the concave surface 141. In the embodiment, each light source 22 is a light emitting diode (LED).

In use, the light rays emitted from the light sources 22 project onto the concave surfaces 141. Because a distance between the light source 22 and the central portion of the corresponding concave surface 141 is longer than a distance between the light source 22 and a peripheral portion of the concave surface 141, a luminous flux of light rays projected onto each point of the concave surface 141 is the same, resulting in uniformity of the light rays emitted from the light guiding plate 100.

Particular embodiments are shown and are described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A light guiding plate, comprising:
a bottom surface;
a light emitting surface opposite to the bottom surface; and
a light incident surface perpendicularly connected between the bottom surface and the light emitting surface;
wherein the light guiding plate defines a plurality of recesses in the light incident surface; each recess comprises a concave surface, and the concave surface is connected between the light emitting surface and the bottom surface; each concave surface forms a smooth curve on the light emitting surface; a distance between two points of the smooth curve the same distance away from the light incident surface gradually decreases along a direction away from the light incident surface.

2. The light guiding plate of claim 1, wherein the smooth curve is a parabola.

3. The light guiding plate of claim 1, wherein the recesses are arranged at equal intervals along a length of the light incident surface.

4. The light guiding plate of claim 1, wherein a width of each recess along an arrangement direction of the recesses is from about 0.02 millimeter (mm) to about 0.04 mm, an interval between two adjacent recesses along an arrangement direction of the recesses is from about 0.01 mm to about 0.03 mm, a maximum distance between the concave surface and the light incident surface is from about 0.02 micrometer (um) to about 0.03 um.

5. The light guiding plate of claim 4, wherein the width of each recess along an arrangement direction of the recesses is about 0.03 mm, the interval between two adjacent recesses along an arrangement direction of the recesses is about 0.02 mm, the maximum distance between the concave surface and the light incident surface is 0.025 um.

6. The light guiding plate of claim 1, wherein a midpoint is defined as a midpoint of the width, the smooth curve is symmetrical about a perpendicular line perpendicular to the light incident surface and passing through the midpoint, a lowest point is an intersection point of the perpendicular line and the smooth curve.

7. The light guiding plate of claim 6, wherein when the lowest point serves as an origin of a coordinate plane, the perpendicular line serves as a Y-axis, and a line perpendicular to the perpendicular line and passing through the lowest point serves as a X-axis, a mathematical equation of the smooth curve is y=x²/0.009.

8. A back light module, comprising:
a light guiding plate, comprising:
a bottom surface;
a light emitting surface opposite to the bottom surface; and
a light incident surface perpendicularly connected between the bottom surface and the light emitting surface;
wherein the light guiding plate defines a plurality of recesses in the light incident surface; each recess comprises a concave surface, and the concave surface is connected between the light emitting surface and the bottom surface; each concave surface forms a smooth curve on the light emitting surface; a distance between two points of the smooth curve the same distance away from the light incident surface gradually decreases along a direction away from the light incident surface; and
a plurality of light sources, each light source facing a centre portion of the concave surface.

9. The back light module of claim 8, wherein the smooth curve is a parabola.

10. The back light module of claim 8, wherein the recesses are arranged at equal intervals along a length of the light incident surface.

11. The back light module of claim 8, wherein a width of each recess along an arrangement direction of the recesses is from about 0.02 millimeter (mm) to about 0.04 mm, an interval between two adjacent recesses along an arrangement direction of the recesses is from about 0.01 mm to about 0.03 mm, a maximum distance between the concave surface and the light incident surface is from about 0.02 micrometer (um) to about 0.03 um.

12. The back light module of claim 11, wherein the width of each recess along an arrangement direction of the recesses is about 0.03 mm, the interval between two adjacent recesses along an arrangement direction of the recesses is about 0.02 mm, the maximum distance between the concave surface and the light incident surface is 0.025 um.

13. The back light module of claim 8, wherein a midpoint is defined as a midpoint of the width, the smooth curve is symmetrical about a perpendicular line perpendicular to the light incident surface and passing through the midpoint, a lowest point is an intersection point of the perpendicular line and the smooth curve.

14. The back light module of claim 13, wherein when the lowest point serves as an origin of a coordinate plane, the perpendicular line serves as a Y-axis, and a line perpendicular to the perpendicular line and passing through the lowest point serves as a X-axis, a mathematical equation of the smooth curve is y=x²/0.009.
